(19) United States
(12) Patent Application Publication
(10) Pub. No.: US 2013/0002230 A1
(43) Pub. Date: Jan. 3, 2013

(54) AC LOAD SOFT START FOR VARIABLE-FREQUENCY POWER SOURCE

(75) Inventor: Richard STARKWEATHER, SR., Hopewell Estates, IL (US)

(73) Assignee: Progress Rail Services Corp.

(21) Appl. No.: 13/171,399

(22) Filed: Jun. 28, 2011

(51) Int. Cl. H02J 3/12

(52) U.S. Cl. 323/321; 323/318; 323/320

(57) ABSTRACT

Systems and methods for providing variable-frequency soft start of an AC load are disclosed. In one exemplary embodiment, a method for starting an alternating current (AC) load with a variable-frequency AC power output includes receiving an indication of a duty cycle for chopping the AC power output during starting of the AC load, and determining a frequency of the AC power output. The method further includes chopping the AC power output at the duty cycle, based on the determined frequency of the AC power output, and providing the chopped AC power output to start the AC load.

### TECHNICAL FIELD

The present disclosure relates to soft-starting alternating current (AC) electrical loads, such as AC motors and, more particularly, to systems and methods for soft-starting AC electrical loads supplied by variable-frequency AC power sources.

### BACKGROUND

During startup, an electric motor initially draws an enormous amount of current from its power source until it reaches full operating speed. This phenomenon, known as locked-rotor amps (LRA), is not only inefficient, but can damage the windings and other components of the motor. Due to LRA, electric motors also generate very high torque during startup, which can unduly stress mechanical components driven by the motor.

Various “soft-start” techniques have been developed to mitigate the LRAs associated with starting electric motors. One such technique uses switching or relay circuitry to gradually increase the period during which the power from the power source is applied to the motor, until the motor is fully started. Another technique involves using resistive circuitry to gradually increase the magnitude of the voltage applied to the motor until the motor is fully started.

U.S. Pat. No. 5,151,642 to Lombardi et al. (“the '642 patent”) describes a system for soft-starting an alternating current (AC) motor supplied by a source of AC electricity. In the system of the '642 patent, when starting the AC motor, a control system detects when the voltage of the source makes zero crossing. Upon detecting a zero crossing, the control system of the '642 patent varies the frequency of a clock signal based on a desired rate at which the motor speed is to change while starting. The varying frequency of the clock signal alters the timing of triggering of thyristors that connect each phase of the source of AC electricity to each phase of the motor. This has the effect of gradually increasing the voltage applied to the motor to produce a commensurate increase in motor speed.

Although the control system of the '642 patent may provide a viable means for soft-starting an AC motor, it may have certain limitations. For example, since the control system triggers the thyristors to achieve a desired rate of increase in motor speed, the control system of the '642 patent may be unable to properly start the motor if the frequency of the source of AC electricity changes during startup. For this same reason, the system of the '642 patent may be incompatible with sources of AC electricity that operate over a broad frequency range.

This disclosure is directed to solving one or more of the problems set forth above.

### SUMMARY

One aspect of the disclosure relates to a method for starting an alternating current (AC) load with a variable-frequency AC power output. The method may include receiving an indication of a duty cycle for chopping the AC power output during starting of the AC load, and determining a frequency of the AC power output. In addition, the method may include chopping the AC power output at the duty cycle, based on the determined frequency of the AC power output, and providing the chopped AC power output to start the AC load.

Another aspect of the disclosure relates to a soft start control system for starting an alternating current (AC) load with a variable-frequency AC power output. In one embodiment, the system may include a sensor configured to output a signal indicative of the AC power output, and also may include an AC soft start controller. The controller may be configured to determine a duty cycle for chopping the AC power output during starting of the AC load, and to determine, based on the signal from the sensor, a frequency of the AC power output. The controller may be further configured to chop the AC power output at the duty cycle, based on the determined frequency of the AC power output. Finally, the controller may provide the chopped AC power output to start the AC load.

Still another aspect of the disclosure relates to a machine. In one embodiment, the machine may include a power source and an AC generator driven by the power source and configured to provide an AC power output having a frequency that varies depending upon a speed of the power source. The machine may further include a sensor configured to output a signal indicative of the AC power output, an AC load powered by the AC power output, and an AC soft start controller for starting the AC load. The AC soft start controller may be configured to determine a duty cycle for chopping the AC power output during starting of the AC load, and to determine, based on the signal from the sensor, a frequency of the AC power output. In addition, the controller may be configured to chop the AC power output at the duty cycle, based on the determined frequency of the AC power output; and to provide the chopped AC power output to start the AC load.

Yet another aspect of the disclosure relates to a soft start control system for starting an alternating current (AC) load with variable-frequency AC power output. The system may include an AC power frequency determination unit configured to determine a frequency of the AC power output, and an AC waveform chopper unit. The AC waveform chopper unit may include a waveform frequency range selector configured to select a frequency range of the AC power output based on the determined frequency of the AC power output, and a soft start ramp selector configured to select an increment of a soft start ramp, the soft start ramp defining a period of time over which the AC load is started and being divided into a plurality of increments corresponding to respective duty cycles for chopping the AC power output. The AC waveform chopper unit may further include an AC waveform chopper timing selector configured to select a timing based on the selected frequency range and on the selected soft start ramp increment, and an AC waveform chopper circuit configured to generate an AC waveform chopper signal based on the selected timing. In addition, the system may include an AC load power unit, which may be configured to chop the AC power output at the duty cycle corresponding to the selected soft start ramp increment, based on the AC waveform chopper signal, and to provide the chopped AC power output to start the AC load.

### BRIEF DESCRIPTION OF THE DRAWINGS

FIG. 1 illustrates a representation of an exemplary machine, consistent with the disclosed embodiments;

FIG. 2 illustrates a representation of an exemplary soft start ramp, consistent with the disclosed embodiments;

FIG. 3 illustrates a representation of an exemplary AC soft start control system, consistent with the disclosed embodiments;

FIG. 4 illustrates a representation of an exemplary AC power frequency determination unit associated with the AC soft start control system, consistent with the disclosed embodiments;

FIG. 5 illustrates a representation of an exemplary AC waveform chopper unit associated with the AC soft start control system, consistent with the disclosed embodiments;

FIG. 6 illustrates a representation of an exemplary AC waveform chopper circuit, consistent with the disclosed embodiments;

FIG. 7 illustrates a representation of an exemplary AC waveform chopper signal profile, consistent with the disclosed embodiments;

FIG. 8 illustrates a representation of a table of exemplary resistor values for the AC waveform chopper circuit, consistent with the disclosed embodiments;

FIG. 9 illustrates a representation of an exemplary AC load power unit, consistent with the disclosed embodiments;

FIG. 10 illustrates an alternative embodiment associated with the AC soft start control system, consistent with the disclosure; and

FIG. 11 illustrates a flowchart representation of an exemplary variable-frequency soft start method, consistent with the disclosure.

### DETAILED DESCRIPTION

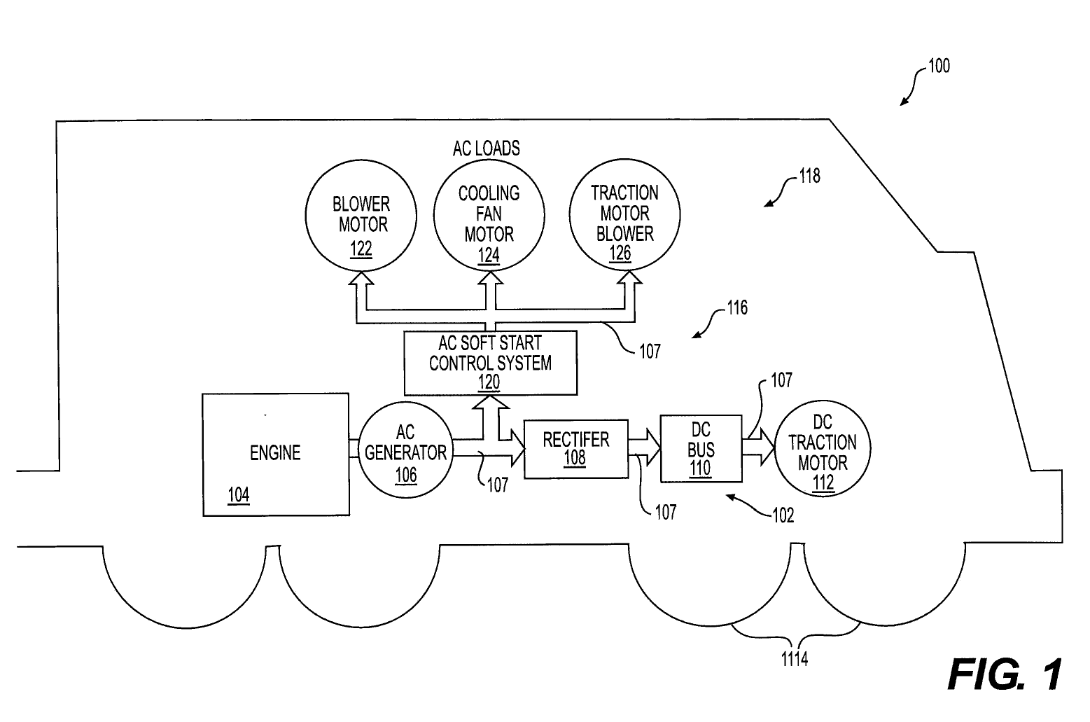

FIG. 1 illustrates a representation of an exemplary machine 100 on which the disclosed embodiments may be implemented. In FIG. 1, machine 100 is illustrated as a mobile machine, in particular, as a railroad locomotive. But in other embodiments, machine 100 may be a stationary machine, such as an offshore oil drilling platform or a power generation station. In addition, it will become apparent upon study of this description that the disclosed embodiments are applicable to other types of machines.

As shown, machine 100 may include a power train 102. In power train 102, an engine 104 may combust fuel to produce a mechanical power output. Engine 104 may be diesel engine, a gasoline engine, a gaseous-fuel driven engine, a turbine engine, or any other type of engine known in the art. The mechanical power output of engine 104 may be coupled to drive an alternating current (AC) generator 106 that generates an AC electrical power output 107, such as an AC permanent-magnet generator, an AC induction generator, an AC synchronous generator, a switched-reluctance generator, or an alternator. By virtue of being coupled to engine 104, the amplitude and frequency of AC power output 107 may vary as the speed of engine 104 changes. For instance, in a locomotive or other mobile machine, AC power output 107 may range from 200-500 VAC and 20-80 Hz, depending upon engine speed.

Power train 102 may further include a rectifier 108. Rectifier 108 may include any circuit components configured to convert AC power output 107 to direct current (DC) power. The DC power may be coupled to a DC bus 110 for storage in associated energy storage device (not shown), such as a capacitor. Power train 102 may further include a direct current (DC) traction motor 112. Responsive to a throttle command from an operator of machine 100, traction motor 112 may draw the electrical energy stored in DC bus 110 to drive one or more traction devices 114 of machine 100, such as wheels that ride on a rail, and propel machine 100.

Continuing with FIG. 1, machine 100 may further include an AC accessory power system 116. As shown, accessory power system 116 may include, for example, one or more AC loads 118 that also draw the AC power output 107 of generator 106 during operation. But depending on the configuration and/or type of machine 100, a separate companion generator or alternator (not shown) driven by engine 104 may instead provide independent AC electrical power to AC loads 118. AC loads 118 may embody any type of AC electrical loads associated with accessory systems of machine 100. As an example, in a locomotive, AC loads 118 may include an AC blower motor 122 for providing cooling air to engine 104, an AC cooling fan motor 124 for providing cooling air to the cabin (not shown) of the locomotive, and/or an AC traction motor blower motor 126 for circulating cooling air over DC traction motor 112. As different types of machines 100 may have different types of accessory systems, AC loads 118 other than those depicted and described herein are contemplated.

As discussed above, AC loads 118, such as motors 122-126, can draw very high current during startup-a phenomenon known as locked rotor amps (LRA). Drawing such a high current is inefficient and can damage the windings and/or other components of motors 122-126, possibly causing them to burn out and fail. Accordingly, consistent with the disclosed embodiments, accessory power system 116 may further include an AC soft start control system 120. Briefly, and as described below, AC soft start control system 120 may start AC loads 118 with the AC power output 107 of generator 106 using a variable-frequency soft start method that reduces the LRA of motors 122-126 during startup. In particular, AC soft start control system 120 may, in real-time, determine the frequency of AC power output 107 which, as discussed above, varies with the speed of engine 104. Based on this determined frequency, AC soft start control system 120 may selectively “chop” or truncate, in the time domain, the AC power output 107 in such a way as to steadily ramp the waveform thereof from a partial waveform to a full waveform as motors 122-126 are started.

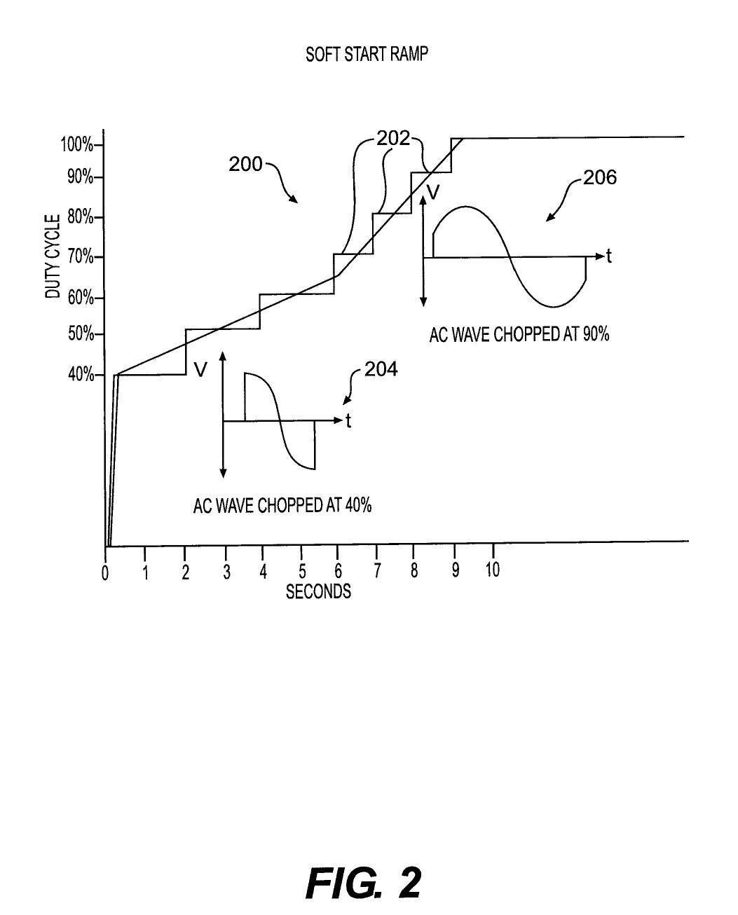

FIG. 2 illustrates a representation of an exemplary soft start ramp 200 that AC soft start control system 120 may apply when starting an AC load 118. Soft start ramp 200 may correspond to an initial startup period during which AC soft start control system 120 selectively chops the waveform of AC power output 107 to allow only a portion of AC power output 107 to pass and power the AC load 118. In the example shown, soft start ramp 200 is made up of nine one-second increments 202. But the parameters of soft start ramp 200 may vary depending upon the type of machine 100, the type of AC loads 118 being started, the voltage swing of generator 106, and/or other factors. In applying soft start ramp 200, AC soft start control system 120 may begin by chopping the waveform of AC power output 107 to provide a waveform 204 chopped at 40% (i.e., a 40% duty cycle) during the 0-1 second increment 202 and the 1-2 second increment 202, and may incrementally increase chopping over the remainder of soft start ramp 200, ending with a waveform 206 chopped at 90% (i.e., a 90% duty cycle) during the 8-9 second increment 202. And after the AC load 118 is started-that is, upon completion of soft start ramp 200-AC soft start control system 120 may terminate chopping and allow the entire unchopped waveform of AC power output 107 (i.e., 100% duty cycle) to pass and power the AC load 118.

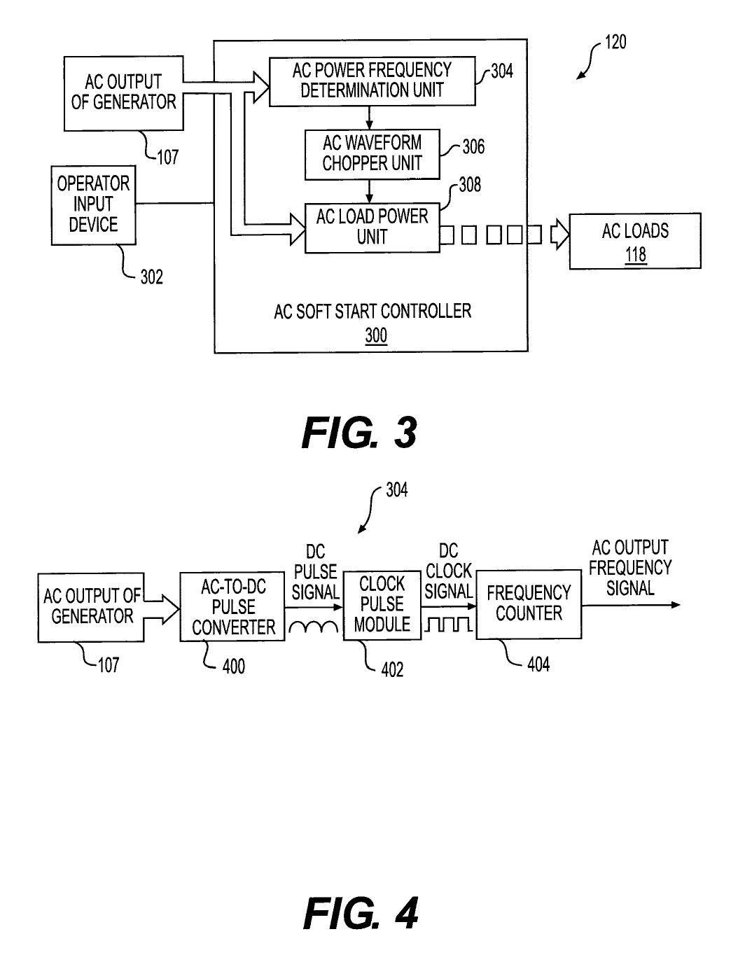

FIG. 3 illustrates a representation of AC soft start control system 120, consistent with the disclosed embodiments. AC soft start control system 120 may include an AC soft start controller 300 and an operator input device 302 operatively coupled to AC soft start controller 300. In one embodiment, AC soft start controller 300 may comprise one or more discrete electrical circuit components that cooperate to perform the disclosed variable-frequency soft start method. In other embodiments, however, AC soft start controller 300 may comprise an onboard computer, such as an electronic control unit (ECU) associated with one or more microprocessors, memory storage devices, mass data storage devices, communication interfaces, and/or other computing components that cooperate to execute computer program instructions to perform the disclosed variable-frequency soft start method. In one embodiment, AC soft start controller 300 may include an AC power frequency determination unit 304, an AC waveform chopper unit 306, and an AC load power unit 308.

FIG. 4 illustrates a representation of AC power frequency determination unit 304. AC power frequency determination unit 304 may comprise one or more components configured to determine, periodically or in real-time, the frequency of the waveform of AC power output 107 which, as discussed above, may vary with the speed of engine 104. In one embodiment, AC power frequency determination unit 304 may include an AC-to-DC pulse converter 400, a clock pulse module 402, and a frequency counter 404.

As shown in FIG. 4, AC-to-DC pulse converter 400 may receive a signal representative of the waveform of AC power output 107. For example, one or more sensors (not shown) associated with generator 106 may measure the amplitude of the voltage or current of AC power output 107 in one or more phases of generator 106, and may output a signal representative of the measured voltage or current amplitude. AC-to-DC pulse converter 400 may then rectify this signal to provide a corresponding DC pulse signal, as shown in FIG. 4. That is, each time the waveform of AC power output 107 crosses zero (i.e., from a positive voltage to a negative voltage or from a negative voltage to a positive voltage), pulse converter 300 may output a corresponding DC pulse having a positive voltage.

Clock pulse module 402 may receive the rectified DC pulse signal from AC-to-DC pulse converter 400, and may output a corresponding DC clock signal, as illustrated. It will be appreciated that each pulse of the DC clock signal will correspond to a point in time at which a positive or negative peak is present in the waveform of AC power output 107. Thus, a pulse of the DC clock signal may indicate that AC power is presently available for starting AC loads 118.

Frequency counter 404 may determine the frequency of the waveform of AC power output 107 based on the DC clock pulse signal from clock pulse module 402. For example, frequency counter 404 may receive the DC clock pulse signal output by clock pulse module 402. Continuously or periodically, frequency counter 404 may count the number of pulses in the DC clock pulse signal that occur within a period of time, such as 1/10^{th} of a second, to calculate the present frequency of the waveform of AC power output 107. In addition, frequency counter 404 may provide an AC output frequency signal indicative of the calculated frequency of the waveform of AC power output 107. As discussed above, in a locomotive, the frequency of AC power output 107 may range from 20-80 Hz, depending upon engine speed.

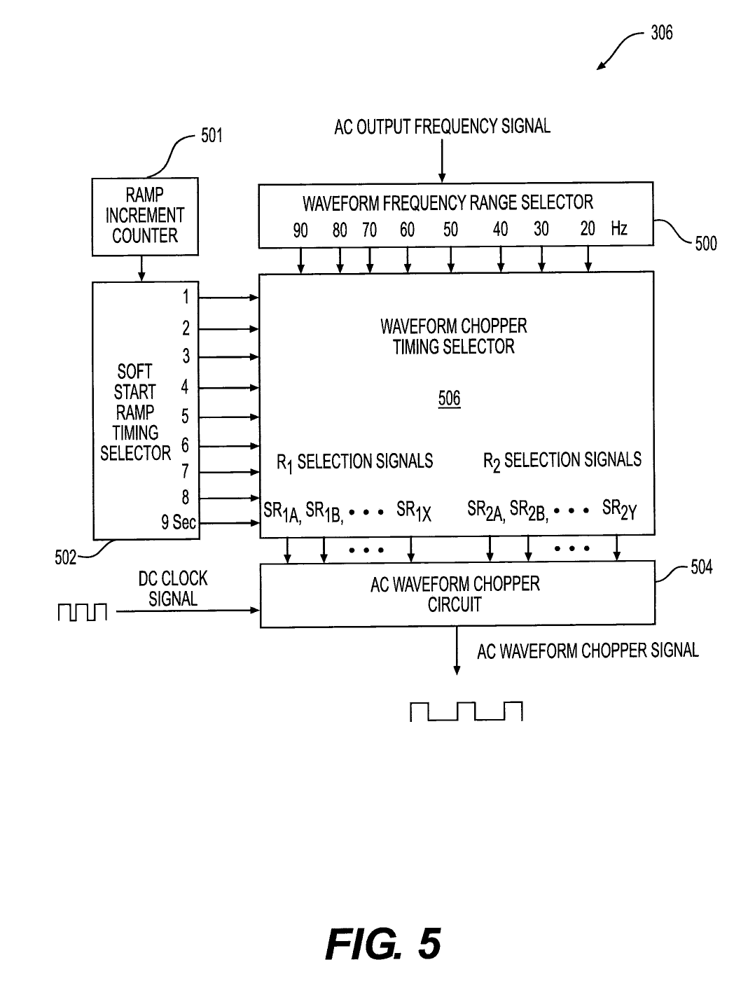

FIG. 5 illustrates a representation of AC waveform chopper unit 306. AC waveform chopper unit 306 may comprise one or more components that cooperate to determine, based on the frequency of the waveform of AC power output 107, a timing required to chop the waveform of AC power output 107 to achieve a desired soft start ramp 200 during startup of AC loads 118. That is, given the present frequency of the waveform of AC output 107, AC waveform chopper unit 306 may determine the timing required to chop the waveform of AC output 107 at a duty cycle that corresponds to each increment 202 of soft start ramp 200 (FIG. 2). As shown, AC waveform chopper unit 306 may include a waveform frequency range selector 500, a soft start ramp increment counter 501, a soft start ramp timing selector 502, an AC waveform chopper circuit 504, and an AC waveform chopper timing selector 506.

Waveform frequency range selector 500 may include any components or modules configured to select ranges within which the present frequency of the waveform of AC power output 107 falls. For example, waveform frequency range selector 500 may receive the AC output frequency signal from frequency counter 404 (FIG. 4), which indicates the present frequency of the waveform of AC power output 107. Periodically or continuously, and based on this signal, waveform frequency range selector 500 may identify within which frequency range, of a plurality of different frequency ranges, lies the present frequency of the waveform of AC power output 107. In the example shown in FIG. 5, waveform frequency range selector 500 determines whether the present frequency of AC power output 107 is within the ranges of 0-20 Hz, 20-30 Hz, 30-40 Hz, 40-50 Hz, 50-60 Hz, 60-70 Hz, 70-80 Hz, and 80-90 Hz. But depending upon the type and configuration of machine 100, and/or on the desired degree of control over chopping, different and/or additional frequency ranges may be chosen. Having determined the frequency range within which the present frequency of the waveform of AC power output 107 falls, waveform frequency range selector 500 may output a signal that indicates this frequency range. For instance, in the example of FIG. 5, waveform frequency range selector 500 outputs a different signal for each of the frequency ranges 0-20 Hz, 20-30 Hz, 30-40 Hz, 40-50 Hz, 50-60 Hz, 60-70 Hz, 70, 80 Hz, and 80-90 Hz.

Since the frequency of AC power output 107 changes, it may fall within different frequency ranges at different points during application of soft start ramp 200, or even within a given increment 202 of soft start ramp 200. In such situations, it is still desirable to maintain chopping of the waveform of AC power output 107 at or near the specified value (i.e., duty cycle). For example, turning back to FIG. 2, assume that during the 3-4 second increment 202 of soft start ramp 200 the frequency of AC power output 107 increases from 32-56 Hz due to a sudden increase in the speed of engine 104. Regardless of this change in the frequency of AC power output 107, it still may be desirable to continue chopping the waveform of AC power output 107 at or near 50%. In such a scenario, over the course of this one-second increment 202, waveform frequency range selector 500 may initially output a first signal corresponding to the 30-40 Hz range, may subsequently output a second signal corresponding to the 40-50 Hz range once the frequency of AC power output 107 exceeds 40 Hz, and may finally output a third signal corresponding to the 50-60 Hz range after the frequency exceeds 50 Hz.

Ramp increment counter 501 may include any components or modules configured to function as a counter with a timing that corresponds to the increments 202 of soft start ramp 200. For example, in an embodiment where soft start ramp 200 is a nine-second ramp with one-second increments 202, ramp increment counter 501 may be a one-second counter, and may output a count signal that indicates the present count. Ramp increment counter 501 may be automatically reset upon completing counting the entire period of soft start ramp 200 (e.g., 9 seconds), that is, when the given AC load 118 is fully started. In addition, ramp increment counter 501 may be manually interrupted and reset upon receiving a reset signal from operator input device 302.

Soft start ramp timing selector 502 may include any components or modules configured to determine the present increment 202 of soft start ramp 200, and to output one or more signals indicating the same. For example, soft start ramp timing selector 502 may receive the ramp count signal from ramp increment counter 501. Based on this signal, soft start ramp timing selector 502 may determine the present increment 202 on soft start ramp 200. Continuing with the example above, soft start ramp timing selector 502 may determine whether it is presently the 0-1 second increment 202, the 1-2 second increment 202, and so on, given the value of the ramp count signal. Soft start ramp timing selector 502 may also output a signal that indicates the determined present increment 202 on soft start ramp 200. For instance, in the example of FIG. 5, soft start ramp timing selector 502 outputs a different signal during each increment 202 of soft start ramp 200: a first signal during the 0-1 second increment 202, a second signal during the 1-2 second increment 202, a third signal during the 2-3 second increment 202, and so on.

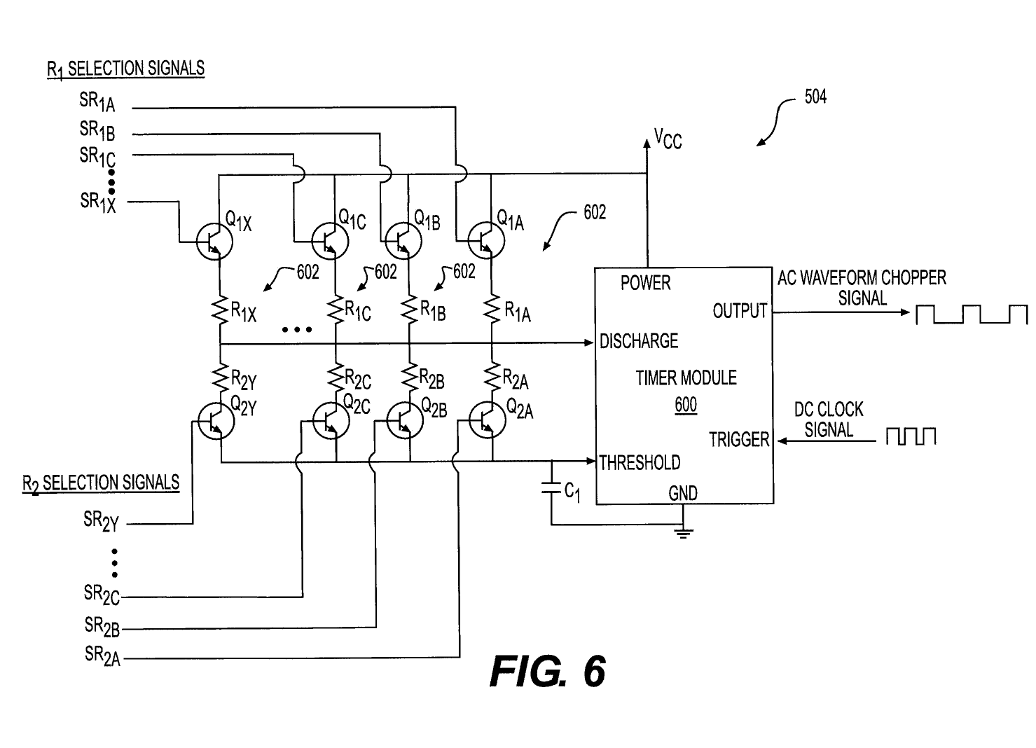

AC waveform chopper circuit 504 may include one or more components configured to output an AC waveform chopper signal with a selected timing, to provide a desired soft start ramp 200 during starting of AC loads 118. As shown in FIG. 6, in one embodiment, AC waveform chopper circuit 504 may include a timer module 600 coupled to a plurality of selectable resistor banks 602.

In one embodiment, timer module 600 may be a “555 timer” or similar circuit, although other configurations may be utilized. Timer module 600 may have a trigger input pin connected to receive the DC clock pulse signal from clock pulse module 402 (FIG. 4). Timer module 600 may also have a ground (GND) pin connected to ground, as well as to a first end of a capacitor C₁ associated with timer module 600. Timer module 600 may further include a threshold pin connected to a second end of the capacitor C₁, as well as to emitters of second selection transistors Q_{2A}-Q_{2Y} in resistor banks 602. A discharge pin of timer module 600 may be connected to first ends of first resistors R_{1A}-R_{1X} in resistor banks 602 as well as to first ends of second resistors R_{2A}-R_{2Y} in resistor banks 602, which ends may be connected to each other. Second ends of first resistors R_{1A}-R_{1X} may be connected to emitters of first selection transistors Q_{1A}-Q_{1X} in resistor banks 602, and second ends of second resistors R_{2A}-R_{2Y} may be connected to collectors of second selection transistors Q_{2A}-Q_{2Y}. A power pin of timer module 600 may be connected to a power supply voltage Vcc, and also to collectors of first transistors Q_{1A}-Q_{1X}, which collectors may be connected to one another. In addition, emitters of second selection transistors Q_{2A}-Q_{2Y} may be coupled to a second end of capacitor C₁ as well as to each other. Finally, an output pin of timer module 600 may output an AC waveform chopper signal to AC load power unit 308 (FIG. 3) to control chopping of AC power output 107 during starting of AC loads 118.

As discussed above, a pulse of DC clock signal may indicate that a pulse of AC power output 107 is available to start an AC load 118 (FIG. 1). Upon receiving a pulse of the DC clock signal at the trigger pin, timer module 600 may drive the AC waveform chopper signal to a high logic voltage, e.g., at or near Vcc. In response, AC load power unit 308 may allow AC power output 107 to pass to the AC load 118, as described in further detail below. The capacitor C₁ may then begin charging toward Vcc through a selected one of first resistors R_{1A}-R_{1X}, a selected one of second resistors R_{2A}-R_{2Y}, and capacitor C₁. Once the voltage of the capacitor C₁ nears the high logic voltage (e.g., ⅔ Vcc), the threshold pin is triggered, and the timer module 600 may drive the AC waveform chopper signal from the high logic voltage to a low logic voltage. As described below, this may cause AC load power unit 308 to now prevent (i.e., chop) AC power output 107 from passing to the AC load 118. It is noted that the period of time T_{ON} that the AC waveform chopper signal is at the high logic voltage, and that AC power output 107 is permitted to pass to the AC load 118, may be

T_{ON}=0.69(R₁+R₂)×C₁,

where R₁ is the resistance of the selected first resistor R_{1A}-R_{1X}, R₂ is the resistance of the selected second resistor R_{2A}-R_{2Y}, and C₁ is the capacitance of capacitor C₁.

At this point, timer module 600 may being discharging capacitor C₁ toward ground through the discharge pin to ground, via the selected second resistor R_{2A}-R_{2Y}. Once the voltage of the capacitor C₁ reaches the logic low voltage (e.g., ⅓ Vcc), timer module 600 may again drive the AC waveform chopper signal, at the output pin, to the high logic voltage, causing AC load power unit 308 to again allow AC power output 107 to pass to the AC load 118 until the voltage of the capacitor C₁ reaches the logic high value (e.g., ⅔ Vcc). Accordingly, the period of time T_{OFF} that the AC waveform chopper signal is low, and that AC power output 107 is prevented from passing to the AC load 118 (i.e., chopped), may be

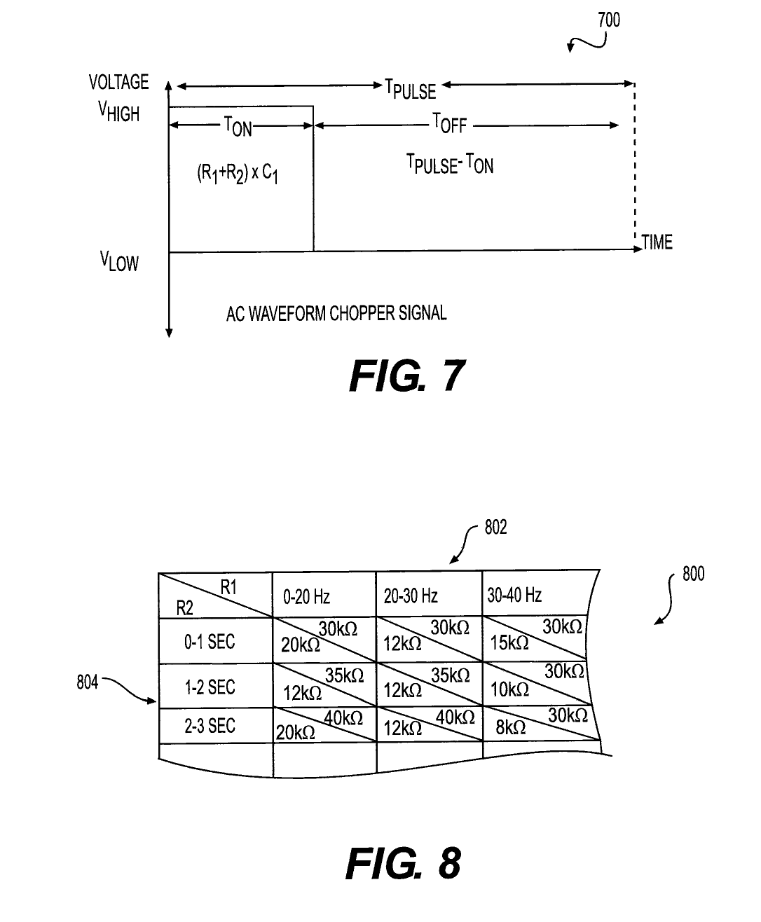

T_{OFF}=0.69×R₂×C₁,

where R₂ is the resistance of the selected second resistor R_{2A}-R_{2Y} and C₁ is the capacitance of capacitor C₁. Accordingly, while an AC pulse is available, timer module 600 may oscillate between charging capacitor C₁ through the selected first resistor R_{1A}-R_{2X} and the selected second resistor R_{2A}-R_{2Y} and discharging capacitor C₁ through the selected second resistor R_{2A}-R_{2Y}, while outputting a corresponding AC waveform chopper signal that has a first value (e.g., a high logic value) while capacitor C₁ is charging and a second value (e.g., a logic low value) while capacitor C₁ is discharging. Thus, timer module 600 may oscillate to provide an AC waveform chopper signal with a timing profile 700 illustrated in FIG. 7. As described below, due to control by waveform chopper timing selector 506, the ratio of T_{ON}/(T_{ON}+T_{OFF}) may equal the duty cycle corresponding to the present increment 202 of soft start ramp 200 (e.g., 40%). And T_{ON}+T_{OFF} may be roughly equal to 1/f_{R}, where f_{R} is the frequency range of AC power output 107, as determined by waveform frequency range selector 500.

Turning back to FIG. 6, as noted above, selectable resistor banks 602 may include first selection transistors Q_{1A}-Q_{1X} for selecting respective first resistors R_{1A}-R_{1X} and second selection transistors Q_{2A}-Q_{2Y} for selecting respective second resistors R_{2A}-R_{2Y}. First resistor selection signals SR_{1A}-SR_{1X}, received from waveform chopper timing selector 506 (FIG. 5), may be coupled to base terminals of respective first selection transistors Q_{1A}-Q_{1X}. When a first resistor selection signal SR_{1A}-SR_{1X}, is driven to a high logic value, the corresponding first selection transistor Q_{1A}-Q_{1X} may turn on, coupling the second end of its first resistor R_{1A}-R_{1X} to the power supply voltage Vcc. Similarly, second resistor selection signals SR_{2A}-SR_{2Y}, also received from waveform chopper timing selector 506, may be coupled to base terminals of respective second selection transistors Q_{2A}-Q_{2X}. When a second resistor selection signal SR_{2A}-SR_{1Y} is driven to a high value, the corresponding second selection transistor Q_{2A}-Q_{2Y} may turn on, coupling the second end of its respective second resistor R_{2A}-R_{2Y} to capacitor C₁.

Returning to FIG. 5, waveform chopper timing selector 506 may comprise one or more components configured to select a desired first resistor R_{1A}-R_{1X} and a desired second resistor R_{2A}-R_{2Y} of resistor banks 602 based on a determined frequency of AC power output 107 and on the present increment 202 of soft start ramp 200. Waveform chopper timing selector 506 may accomplish this selection by responsively outputting a first resistor selection signal SR_{1A}-SR_{1X} and a second resistor selection signal SR_{2A}-SR_{2Y} that correspond to the present frequency of AC power output 107 and to the present increment 202 of soft start ramp 200. In particular, waveform chopper timing selector 506 may receive from waveform frequency range selector 500 the frequency selection signal indicating the determined frequency range (e.g., 40-50 Hz) within which the present frequency of AC power output 107 lies. Waveform chopper timing selector 506 may also receive from soft start ramp timing selector 502 the selection signal indicating the determined present increment 202 of soft start ramp 200. Based on these signals, waveform chopper timing selector 506 may select a first resistor R_{1A}-R_{1X} and a second resistor R_{2A}-R_{2Y} of resistor banks 602 such that the AC waveform chopper signal output by AC waveform chopper circuit 504 has a duty cycle (e.g., 50%) that corresponds to the present increment 202 of soft start ramp 200. For example, waveform chopper timing selector 506 may responsively select the first resistor R_{1A}-R_{1X} and the second resistor R_{2A}-R_{2Y} such that:

T_{ON}=0.069(R₁+R₂)×C₁=I_{Soft Start}/f_{R},

where T_{ON} is the period of time that the AC waveform chopper signal has a high logic voltage, R₁ is the resistance of the selected first resistor R_{1A}-R_{1X}, R₂ is the resistance of the selected second resistor R_{2A}-R_{2Y}, C₁ is the capacitance of capacitor C₁, I_{Soft/Start} is the duty cycle (e.g., 40%) of the present increment 202 of soft start ramp 200, and f_{R} is the present frequency range of the waveform of AC power output 107. In other words, the combination of the selected first resistor R_{1A}-R_{1X} and the second resistor R_{2A}-R_{2Y} may result in the period of time T_{ON} that the AC waveform chopper signal is high being equal to the duty cycle (e.g., 40%) of the present increment 202 of soft start ramp 200, given the present frequency range f_{R} of the waveform of AC power output 107.

To illustrate, FIG. 8 shows a table 800 of exemplary values of first resistors R_{1A}-R_{1X} and second resistors R_{2A}-R_{2Y} that may be selected for specific combinations of frequency ranges 802 of AC power output 107 and soft start ramp increments 804, when C₁ is 0.55 μF. The specific values and/or combinations of first resistors R_{1A}-R_{1X} and second resistors R_{2A}-R_{2Y} may be chosen by a designer of AC soft start control system 120, based on the characteristics of generator 106, AC loads 118, AC waveform chopper circuit 504, and/or other factors, to achieve a desire soft start ramp 200. It is noted, however, that the values shown in table 800 are exemplary only, as circuit components having different values may be used depending upon the particular implementation of AC soft start control system 120.

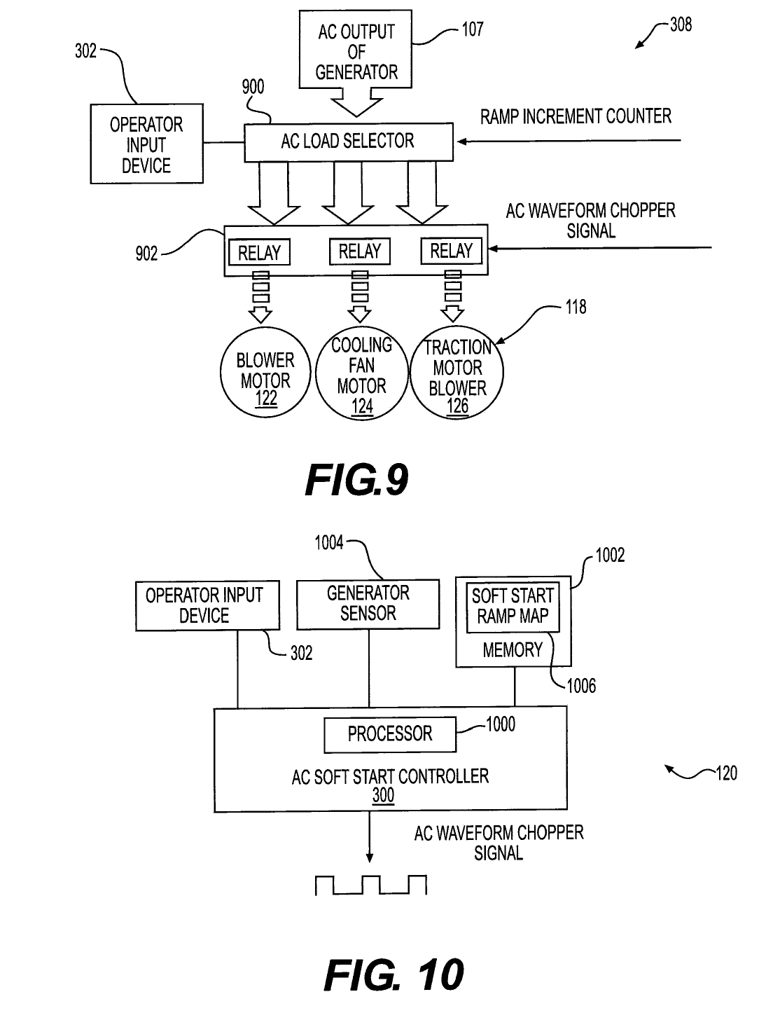

FIG. 9 illustrates a representation of AC load power unit 308, consistent with the disclosed embodiments. Briefly, AC load power unit 308 may be configured to switch AC power output 107 to start a selected one of AC loads 118. AC load power unit 308 may also be configured to chop the AC power output 107 provided to the selected AC load 118, based on the AC waveform chopper signal received from AC waveform chopper circuit 504. In one embodiment, AC load power unit 308 may include an AC load selector 900 and one or more solid state relays 902.

AC load selector 900 may comprise any switching circuitry configured to switch or otherwise couple AC power output 107 to a selected AC load 118 for soft-starting. In some embodiments, AC load selector 900 may be coupled to receive a command signal from operator input device 302 that indicates a selected AC load 118 for starting. As an example, an operator of AC soft start control system 120, such as a locomotive engineer, may provide input to operator input device 302 selecting blower motor 122 for starting. In response, AC load selector 900 may switch AC power output 107 to blower motor 122. In some embodiments, AC load selector 900 may receive the signal from ramp increment counter 501, and/or the signals from soft start ramping timing selector 502, indicating the present increment 202 of soft start ramp 200. Based on this, and upon receiving a start command from operator input device 302, AC load selector 900 may sequentially switch AC power output 107 to each AC load 118 for application of soft start ramp 200. In one embodiment, AC load selector 900 may determine that a given AC load 118 is fully started, and may switch AC power output 107 to start the next AC load 118, when the received signals indicate that the period (e.g., 9 seconds) of the soft start ramp 200 for the AC load 118 has elapsed.

Solid state relays 902 may include any components for selectively coupling and decoupling (i.e., chopping) AC power output 107 to AC loads 118 in response to a control signal. In one embodiment, a solid state relay 902 may be provided for each AC load 118, as shown in FIG. 9. Solid state relays 902 may receive the AC waveform chopper signal from AC waveform chopper circuit 504, and may responsively chop AC power output 107 in accordance with the duty cycle of the AC waveform chopper signal. For instance, when the AC waveform chopper signal has a high logic value, a solid state relay 902 may allow AC power output 107 to pass to its respective AC load 118. When the AC waveform chopper signal has a low value, on the other hand, a solid state relay 902 may prevent (i.e., chop) AC power output 107 from passing to its respective AC load 118.

FIG. 10 illustrates an alternative embodiment of AC soft start control system 120. In the embodiment of FIG. 10, AC soft start controller 300 may comprise, for example, an onboard computer having a processor 1000, a memory device 1002, and/or other computing elements that cooperate to perform a variable-frequency soft start method consistent with the disclosure. A generator sensor 1004 and operator input device 302 may also be in communication with AC soft start controller 300.

Processor 1000 may comprise any general- or special-purpose computer processor configured to execute computer program instructions stored in memory to perform a variable-frequency soft start method consistent with the disclosure. For example, processor 1000 may comprise one or more central processing units (CPU), microprocessors, integrated circuits (IC), such as an application-specific integrated circuit (ASIC), or other computer processing elements known in the art.

Memory device 1002 may comprise any type of static, dynamic, volatile, and/or nonvolatile data storage device known in the art. In one embodiment, memory device 1002 may store a soft start ramp map 1006. Soft start ramp map 1006 may associate a plurality of soft start increments 202 of soft start ramp 200 with corresponding duty cycles for chopping AC power output 107 during starting of AC loads 118. Continuing with soft start ramp 200 discussed above in connection with FIG. 2 as an example, soft tart ramp map 1006 may prescribe chopping of AC power output 107 during each one-second increment 202 of a nine-second soft start ramp 200 as follows:

| Increment | Chopper Duty Cycle |
|---|---|
| 0-1 seconds | 40% |
| 0-2 seconds | 40% |
| 2-3 seconds | 50% |
| 3-4 seconds | 50% |
| 4-5 seconds | 60% |
| 5-6 seconds | 60% |
| 6-7 seconds | 70% |
| 7-8 seconds | 80% |
| 8-9 seconds | 90% |

Generator sensor 1004 may be any sensor in communication with AC generator 106 and configured to determine the voltage or current of AC power output 107 in one or more phases of generator 106. And sensor 1004 may output a signal representative of the same. Generator sensor 1004 may comprise any type of sensor known in the art, such as a physical electrical sensor or a virtual software sensor associated with AC soft start controller 300.

AC soft start controller 300 may be configured to determine the present frequency of the waveform of AC power output 107. For example, AC soft start controller 300 may receive the signal from generator sensor 1004 and calculate the number of times the voltage of AC power output 107 crosses zero within a given period of time, such as 1/10^{th} of a second. Alternatively or additionally, AC soft start controller 300 may be configured to calculate the present frequency of AC power output 17 by determining a rate of change of AC power output over a period of time, regardless of whether the signal crosses zero.

AC soft start controller 300 may be further configured to determine the present increment 202 of soft start ramp 200. For example, upon receiving a start command signal from operator input device 302, AC soft start controller 300 may begin counting one-second increments. In addition AC soft start controller 300 may look up the present increment 202 in soft start ramp map 1006 to determine the chopping of AC power output 107 specified for that increment 202.

Upon detecting a pulse in AC power output 107 (e.g., based on the DC clock pulse signal and/or when the amplitude of AC power output makes a zero crossing), AC soft start controller 300 may be further configured to generate and output an AC waveform chopper signal to AC load power unit 308. The AC waveform chopper signal may be based on the determined present frequency of the waveform of AC power output 107 and on the specified chopping duty cycle for the present soft start increment 202. For example, AC soft start controller 300 may calculate a period of time T_{ON} during which the detected pulse of AC power output 107 is permitted to pass to the AC load 118:

T_{ON}=I_{Soft Start}/f_{G},

where I_{Soft Start} is the chopping duty cycle (e.g., 40%) of the present increment 202 of soft start ramp 200 determined from map 1006 and f_{G} is the determined present frequency of the waveform of AC power output 107. AC soft start controller 300 may also be configured to determine a period of time T_{OFF} during which AC power output 107 is prevented from passing to the AC load 118 (i.e., chopped):

T_{OFF}=1/f_{G}−T_{ON},

where f_{G} is the determined present frequency of the waveform of AC power output 107. AC soft start controller 300 may then generate and output to AC load power unit 308 an AC waveform chopper signal that has a high logic value for the period time T_{ON} and a low logic value for the period of time T_{OFF}.

Returning to FIG. 3, operator input device 302 may include one or more mechanisms that permit an operator of machine 100 to input information or commands to AC soft start control system 120. For example, operator input device 302 may include a keyboard, a touch screen, a touch pad, a mouse, a keypad, a switch, a knob, a lever, or any other type of device for enabling operator input to a control system. In one embodiment, operator input device 302 may allow the operator to input a start command that initiates soft-starting of AC loads 118, a stop command that terminates soft-starting of AC loads 118, a reset command that resets soft-starting of AC loads 118, and/or a selection command that selects a desired one of AC loads 118 for soft-starting.

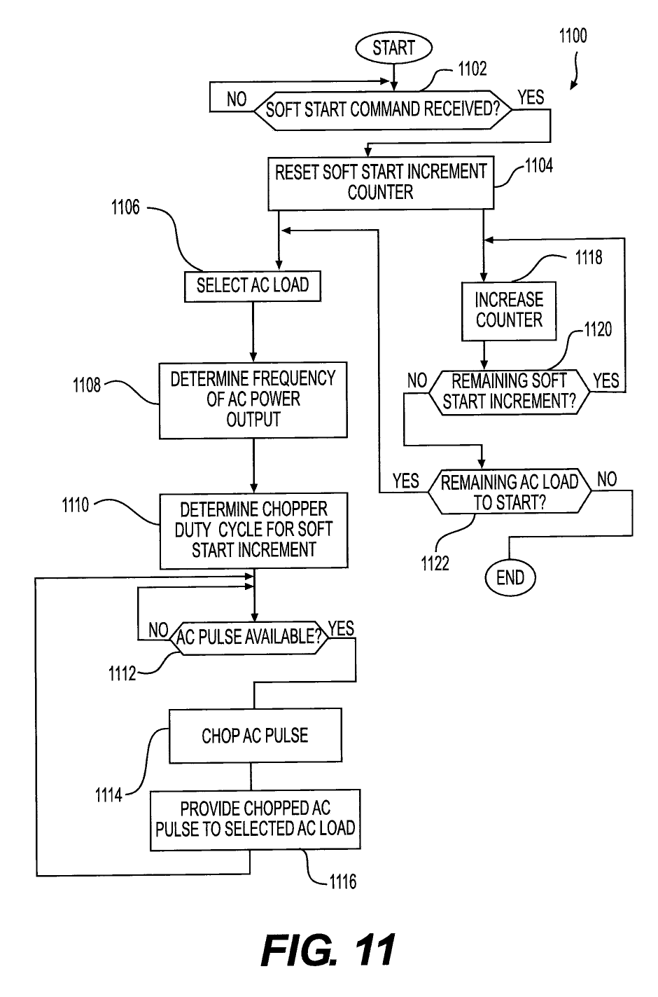

FIG. 11 illustrates a flowchart of an exemplary variable-frequency soft start method 1100 performed by AC soft start control system 120, consistent with the disclosed embodiments. In particular, method 1100 may be performed by processor 1000 executing computer program instructions stored in memory associated with AC soft start controller 300.

Initially, AC soft start controller 300 may determine whether a command to soft start an AC load 118 is received (step 1102). For example, AC soft start controller 300 may receive a soft start command signal from operator input device 302 when the operator presses a start button thereof. If not, AC soft start controller 300 may wait to receive a soft start command. If a soft start command is received, AC soft start controller 300 may reset a soft start ramp increment counter 501, for example, to zero seconds (step 1104).

AC soft start controller 300 may further select an AC load 118 for starting (step 1106). For example, in one embodiment, AC soft start controller 300 may be configured to automatically start each of AC loads 118 in sequence, and may first select blower motor 122 for soft-starting before moving on to start the remaining AC loads 118. In another embodiment, the operator may provide input to operator input device 302 to select a desired AC load 118 for starting.

AC soft start controller 300 may further determine the frequency of the waveform of AC power output 107 (step 1108). As discussed, changes in the speed of engine 104 may cause the frequency of AC power output 107 to vary over the course of starting the selected AC load 118. For example, during the first two seconds of starting blower motor 122, the frequency of AC power output 107 may increase from 20-56 Hz due to a sudden increase in the speed of engine 104. Accordingly, in connection with step 1108, AC soft start controller 300 may receive the signal from generator sensor 1004 indicating the amplitude of the voltage or current of AC power output 107. And periodically or continuously during starting of the selected AC load 118, AC soft start controller 300 may determine the frequency by calculating the number of times the amplitude crosses zero within a given period of time (e.g., 1/10^{th} of a second), or by computing a rate of change of the amplitude over a certain period of time, even if the amplitude does not cross zero during that time. Alternatively, in step 1108, waveform frequency range selector 500 may output one of several signals indicating the present frequency range of the waveform of AC power output 107, as described above.

AC soft start controller 300 may further determine the chopper duty cycle for the present soft start ramp increment 202 (step 1110). In one embodiment, AC soft start controller 300 may look up the present count value of soft start ramp increment counter 501 in soft start ramp map 1006 and determine the chopper duty cycle to which it corresponds. For example, if the present count value of soft start ramp increment counter 501 is two seconds, corresponding to the 2-3 second increment 202 of soft start ramp 200, AC soft start controller 300 may retrieve a chopper duty cycle of 50% from map 1006. In another embodiment, soft start ramp timing selector 502 may output a signal indicating the present soft start ramp increment 202 based on the present count value of soft start ramp increment counter 501.

AC soft start controller 300 may further determine whether a pulse of AC power output 107 is available for starting the selected AC load 118 (step 1112). For example, in one embodiment, AC soft start controller 300 may determine that a pulse of AC power output 107 is available if a pulse is present in the DC pulse signal output by clock pulse module 402. Alternatively, AC soft start controller 300 may determine that a pulse of AC power output 107 is available if the signal from generator sensor 1004 indicates that the amplitude of AC power output 107 crosses zero, or is above or below zero by more than a threshold amount (e.g., 20 V). If no pulse of AC power output 107 is available, AC soft start controller 300 may wait for a pulse of AC power output 107 to be present.

If it is determined in step 1112 that a pulse of AC power output 107 is available for starting the selected AC load 118, AC soft start controller 300 may chop the AC pulse, based on the frequency of AC power output 107 determined in step 1108 and on the chopper duty cycle determined in step 1110 (step 1114). For example, in connection with step 1114, AC soft start controller 300 may calculate a period of time T_{ON} during which a portion of that pulse of AC power output 107 is permitted to pass to the AC load 118:

T_{ON}=I_{Soft Start}/f_{G},

where I_{Soft Start} is the chopping duty cycle (e.g., 50%) for the present soft start increment 202 as determined in step 1110, and f_{G} is the present frequency of the waveform of AC power output 107 as determined in step 1108. Also in step 1114, AC soft start controller 300 may determine a period of time T_{OFF} to prevent (i.e., chop) the pulse of AC power output 107 from passing to the AC load 118:

T_{OFF}=1/f_{G}−T_{ON},

where f_{G} again is the present frequency of the waveform of AC power output 107 as determined in step 1108. AC soft start controller 300 may then generate an AC waveform chopper signal that has a high logic voltage for the period time T_{ON} and a low logic voltage for the period of time T_{OFF}.

Alternatively, in step 1114, waveform chopper timing selector 506 may output a first resistor selection signal SR_{1A}-SR_{1X} and second resistor selection signal SR_{2A}-SR_{2Y} that correspond to the frequency range of AC power output 107 as determined in step 1108 and to the chopper duty cycle as determined in step 1110. As described above, these signals may respectively select a corresponding first resistor R_{1A}-R_{1X} and a corresponding second resistor R_{2A}-R_{2Y} in resistor banks 602, such that timer module 600 outputs an AC waveform chopper signal that has a high logic voltage for a period of time:

T_{ON}=0.69(R₁+R₂)×C₁=I_{Soft Start}/f_{R},

where R₁ is the resistance of the selected first resistor R_{1A}-R_{1X}, R₂ is the resistance of the selected second resistor R_{2A}-R_{2Y}, C₁ is the capacitance of capacitor C₁, I_{Soft Start} is the chopper duty cycle (e.g., 50%) determined in step 1110, and f_{R} is the present frequency range of the waveform of AC power output 107 as determined in step 1108. The selected first resistor R_{1A}-R_{1X} and second resistor R_{2A}-R_{2Y} may further result in the output AC waveform chopper signal that has low logic value for a period of time:

T_{OFF}=0.69×R₂×C₁,

where R₂ is the resistance of the selected second resistor R_{2A}-R_{2Y} and C₁ is the capacitance of capacitor C₁.

AC soft start controller 300 may then provide the chopped pulse of AC power output 107 to the selected AC load (step 1116). In particular, the solid-state relay 902 associated with the selected AC load 118 may receive the AC waveform chopper signal generated in step 1114. And the solid-state relay 902 may permit a portion of the AC pulse to pass to the selected AC load 118 when the AC waveform chopper signal has the high logic value and may prevent the remaining portion of the AC pulse to pass to the selected AC load 118 when the AC waveform chopper signal has the low logic value. Upon completing chopping the AC pulse in step 1116, processing may return to step 1112, where AC soft start controller 300 may determine whether another pulse of AC power output 107 is available to continue starting the selected AC load 118 and, if so, repeat steps 1114 and 1116 to chop the pulse and provide the chopped pulse to the selected AC load 118.

In parallel with one or more of steps 1106-1116, AC soft start controller 300 may increase the count of soft start ramp increment counter 501 after a certain amount of time elapses (step 1118). For example, referring to FIG. 2, the count may initially be one second, which corresponds to a soft start increment 202 having a 40% duty cycle. After an additional second elapses, AC soft start controller 300 may increase the count to two seconds, which corresponds to a soft start increment 202 having a 50% duty cycle.

AC soft start controller 300 may also determine whether there are any remaining increments 200 in soft start ramp 200, based on the count of soft start ramp increment counter 501 (step 1120). In other words, in step 1120, AC soft start controller 300 may determine whether the selected AC load 118 is fully started. For instance, in the example shown in FIG. 2, if the count is nine seconds or less, AC soft start controller 300 may determine that there is a remaining increment 202 in soft start ramp 200, and that the selected AC load 118 is not yet fully started. If any increments 202 remain in soft start ramp 200, step 1118 may repeat.

If no increments 202 remain in soft start ramp 200, soft start ramp 200 is complete, and the selected AC load 118 has been fully started. Accordingly, AC soft start controller 300 may determine whether there are any remaining AC loads 118 to start (step 1122). For example, upon starting blower motor 122, AC soft start controller 300 may determine that cooling fan motor 124 and traction motor blower motor 126 still have to be started.

If AC soft start controller 300 determines in step 1122 that at least one AC load 118 still has to be started, processing may return to step 1106, in which AC soft start controller 300 may select the next AC load 118 to be started. For example, after starting blower motor 122, AC load selector 900 may automatically switch AC power output 107 to start cooling fan motor 124. Subsequently, steps 1108-1116 may be repeated to soft start cooling fan motor 124.

### INDUSTRIAL APPLICABILITY

The described AC soft start control system may have general application for starting any type AC load or system that benefits from soft-starting. For example, the disclosed AC soft start control system may have application to reduce the large currents drawn by AC motors at startup, which wastes power and can damage the windings of the motors.

The described AC soft start system 120 may have specific application to systems in which an AC generator that outputs AC power over a broad frequency range powers AC loads of a variety of horsepower. For example, in a locomotive or other type of machine in which an AC generator is driven by a combustion engine, the frequency of the power output of the generator can change dramatically with the speed of the engine. The described AC soft start system, however, has functionality to determine the frequency of the AC power output of the generator, and to chop the AC power output provided to an AC load during starting accordingly, to achieve a desired soft start ramp. Thus, a desired soft start ramp can be maintained even though the generator operates at different speeds and provides variable-frequency AC power and/or AC power at different frequency ranges.

One skilled in the art will appreciate that computer programs for implementing the disclosed variable-frequency soft start method 1100 may be stored on, and/or read from, computer-readable storage media. The stored instructions, when executed by a computer associated with AC soft start control system 120, may cause the computer to perform, among other things, the processes disclosed herein. Exemplary computer-readable storage media may include magnetic storage devices, such as a hard disk, a floppy disk, magnetic tape, or another magnetic storage device known in the art; optical storage devices, such as CD-ROM, DVD-ROM, or another optical storage device known in the art; and/or electronic storage devices, such as EPROM, a flash drive, or another integrated circuit storage device known in the art. The computer-readable storage media may be embodied by or in one or more components of AC soft start control system 120, such as in memory associated with AC soft start controller 300.

It will be apparent to those skilled in the art that various modifications and variations can be made to the disclosed systems and methods without departing from the scope of the disclosure. Other embodiments of the disclosed mobile machine and methods will be apparent to those skilled in the art from consideration of the specification and practice of the power system and methods disclosed herein. It is intended that the specification and examples be considered as exemplary only, with a true scope of the disclosure being indicated by the following claims and their equivalents.

What is claimed is:

1. A method for starting an alternating current (AC) load with a variable-frequency AC power output, the method comprising:
receiving an indication of a duty cycle for chopping the AC power output during starting of the AC load; and
determining a frequency of the AC power output;
chopping the AC power output at the duty cycle, based on the determined frequency of the AC power output; and
providing the chopped AC power output to start the AC load.

2. The method of claim 1, wherein receiving an indication of a duty cycle for chopping the AC power output includes:
accessing a soft start ramp map defining a period time over which the AC load is started, the soft start ramp map being divided into a plurality of soft start ramp increments corresponding to respective duty cycles for chopping the AC power output;
determining a present increment of the soft start ramp; and
determining, from the soft start ramp map, the duty cycle that corresponds to the present soft start ramp increment.

3. The method of claim 2, wherein determining a present increment of the soft start ramp includes receiving a count value from a soft start ramp increment counter.

4. The method of claim 2, wherein the soft start ramp map associates earlier soft start ramp increments with shorter duty cycles than the soft start ramp map associates with later soft start ramp increments.

5. The method of claim 1, wherein determining a frequency of the AC power output includes:
receiving a signal from a sensor associated with an AC generator producing the AC power output, the signal indicating an amplitude of the AC power output; and
determining a number of times that the amplitude crosses zero within a period of time.

6. The method of claim 1, wherein chopping the AC power output includes:
determining a first period of time T_{ON}=I_{Soft Start}/f_{G}, where I_{Soft Start} is a percentage representing the duty cycle and f_{G} is the determined frequency of the AC power output;
determining a second period of time T_{OFF}=1/f_{G}−T_{ON}; and
generating an AC waveform chopper signal that has a first value for the first period of time T_{ON} and a second value for the second period of time T_{OFF}.

7. The method of claim 6, wherein chopping the AC power output further includes providing the AC waveform chopper signal to a solid state relay that couples the AC power output to the AC load when the AC waveform chopper signal has the first value and decouples the AC power output from the AC load when the AC waveform chopper signal has the second value.

8. The method of claim 1, further including detecting an AC pulse of the AC power output, wherein chopping includes chopping the AC pulse at the duty cycle, based on the determined frequency of the AC power output.

9. The method of claim 1, further including, upon completing starting the AC load, automatically providing the chopped AC power output to start a second AC load.

10. A soft start control system for starting an alternating current (AC) load with a variable-frequency AC power output, the system comprising:
a sensor configured to output a signal indicative of the AC power output; and
an AC soft start controller configured to:
determine a duty cycle for chopping the AC power output during starting of the AC load;
determine, based on the signal from the sensor, a frequency of the AC power output;
chop the AC power output at the duty cycle, based on the determined frequency of the AC power output; and
provide the chopped AC power output to start the AC load.

11. The system of claim 10, further comprising a memory device storing a soft start ramp map defining a period time over which the AC load is started, the soft start ramp map being divided into a plurality of soft start ramp increments corresponding to respective duty cycles for chopping the AC power output, wherein the AC soft start controller is further configured to:
determine a present increment of the soft start ramp; and
determine, from the soft start ramp map, the duty cycle that corresponds to the present soft start ramp increment.

12. The system of claim 11, wherein the AC soft start controller is configured to determine the present soft start ramp increment based on a count value of a soft start ramp increment counter.

13. The system of claim 11, wherein the soft start ramp map associates earlier soft start ramp increments with shorter duty cycles than the soft start ramp map associates with later soft start ramp increments.

14. The system of claim 10, wherein the AC soft start controller is configured to chop the AC power output by:
determining a first period of time T_{ON}=I_{Soft Start}/f_{G}, where I_{Soft Start} is a percentage representing the duty cycle and f_{G} is the determined frequency of the AC power output;
determining a second period of time T_{OFF}=1/f_{G}−T_{ON}; and
generating an AC waveform chopper signal that has a first value for the first period of time T_{ON} and a second value for the second period of time T_{OFF}.

15. The system of claim 14, further comprising a solid state relay that couples the AC power output to the AC load when the AC waveform chopper signal has the first value and decouples the AC power output from the AC load when the AC waveform chopper signal has the second value.

16. The system of claim 10, wherein the AC soft start controller is further configured to:
detect an AC pulse of the AC power output; and
chop the AC power output by chopping the AC pulse at the duty cycle, based on the determined frequency of the AC power output.

17. The system of claim 10, wherein the AC soft start controller is further configured to automatically provide the chopped AC power output to start a second AC load upon completion of starting the AC load.

18. A machine, comprising:
a power source;
an AC generator driven by the power source and configured to provide a AC power output having a frequency that varies depending upon a speed of the power source;
a sensor configured to output a signal indicative of the AC power output;
an AC load powered by the AC power output; and
an AC soft start controller for starting the AC load, the AC soft start controller being configured to:
determine a duty cycle for chopping the AC power output during starting of the AC load; and
determine, based on the signal from the sensor, a frequency of the AC power output;
chop the AC power output at the duty cycle, based on the determined frequency of the AC power output; and
provide the chopped AC power output to start the AC load.

19. A soft start control system for starting an alternating current (AC) load with variable-frequency AC power output, the system comprising:
an AC power frequency determination unit configured to determine a frequency of the AC power output;
an AC waveform chopper unit, comprising:
a waveform frequency range selector configured to select a frequency range of the AC power output based on the determined frequency of the AC power output;
a soft start ramp selector configured to select an increment of a soft start ramp, the soft start ramp defining a period of time over which the AC load is started and being divided into a plurality of increments corresponding to respective duty cycles for chopping the AC power output;
an AC waveform chopper timing selector configured to select a timing based on the selected frequency range and on the selected soft start ramp increment; and
an AC waveform chopper circuit configured to generate an AC waveform chopper signal based on the selected timing; and
an AC load power unit configured to:
chop the AC power output at the duty cycle corresponding to the selected soft start ramp increment, based on the AC waveform chopper signal; and
provide the chopped AC power output to start the AC load.

20. The system of claim 19, wherein:
the AC waveform chopper circuit includes a timer module, a plurality of resistors, and a capacitor, and is configured to:
oscillate by charging and discharging the capacitor through selected resistors of the plurality of resistors; and
generate the AC waveform chopper signal based on the oscillation; and
the AC waveform chopper timing circuit selects the timing by providing at least one resistor selection signal to the AC waveform chopper circuit to select at least one of the plurality of resistors through which the capacitor charges or discharges.
